(19) United States
(12) Patent Application Publication
(10) Pub. No.: US 2026/0221155 A1
(43) Pub. Date: Jul. 30, 2026

(54) SUBSTRATE FOR MAGNETIC DISK

(71) Applicants: FURUKAWA ELECTRIC CO., LTD., Tokyo (JP); UACJ Corporation, Tokyo (JP)

(72) Inventors: Hideyuki HATAKEYAMA, Tokyo (JP); Koichiro TAKIGUCHI, Tokyo (JP)

(21) Appl. No.: 19/151,621

(22) PCT Filed: Jan. 26, 2024
(86) PCT No.: PCT/JP2024/002473

§ 371 Date: Jul. 29, 2025

(30) Foreign Application Priority Data
Feb. 1, 2023 (JP) 2023-014136

(51) Int. Cl. G11B 5/73; G11B 5/82; G11B 5/84

(52) U.S. Cl. CPC G11B 5/73921; G11B 5/8404; G11B 5/82

(57) ABSTRACT

The purpose of the present invention is to provide a substrate for a magnetic disk that effectively minimizes the occurrence of head crashes by effectively minimizing undulation present in the outer peripheral area of the disk surface even if it is thin, particularly. The present invention is a substrate for a magnetic disk having a maximum value of arithmetic mean heights Sa of 0.50 nm or less and a standard deviation of the arithmetic mean heights Sa of 0.10 nm or less when the arithmetic mean heights Sa are defined by ISO25178 and are each measured in a plurality of field-of-view areas located on the outer peripheral area of at least one side using scanning optical interferometry in a middle wavelength area through a Gaussian filter with a cutoff wavelength of 1.0 mm.

### TECHNICAL FIELD

The present invention relates to a substrate for a magnetic disk. More specifically, the present invention relates to a substrate for a magnetic disk that can effectively prevent occurrence of a head crash by effectively preventing waviness present in an outer peripheral area on a surface of a disk even if the wall is thin.

### BACKGROUND ART

In recent years, due to rapid spread of cloud computing, hard disks for use in data centers are required to have increased capacities. To support this, measures have been taken that include increase in diameters of substrate for a magnetic disk, and increase in the number of arranged substrates through reduction in thickness. However, the sizes of housings for hard disks are standardized and accordingly, it is difficult to increase the diameters more. Consequently, further reduction in thickness of the substrate for a magnetic disk has been strongly demanded. It is however known that the substrate with a reduced thickness has a reduced stiffness and tends to cause deformation, and accordingly, tends to develop waviness on the disk when rotating at high speed. Waviness is a major factor of collision between the magnetic disk and a magnetic head, and is required to be lowered.

Some discussions have been made to reduce the physical error, such as a head crash, in the hard disk. For example, Patent Document 1 discloses a glass substrate that has a high cleaning level and a high smoothness (specifically, meaning that it is so smooth that the average surface roughness (Ra) on the surface is less than 0.3 nm) easily achieved by acid treatment.

### CITATION LIST

### Patent Document

Patent Document 1: Japanese Patent No. 3959588

### DISCLOSURE OF THE INVENTION

### Problems to be Solved by the Invention

A glass substrate described in Patent Document 1 has a smooth surface obtained through adjustment to reduce the average surface roughness (Ra) that is a two-dimensional surface texture detected by line measurement. The thin-wall substrate as described above has an insufficient stiffness, and tends to cause deformation. Accordingly, a head crash cannot be prevented only by adjusting the two-dimensional surface texture in some cases.

The present invention has an object to provide a substrate for a magnetic disk that effectively prevents occurrence of a head crash by effectively preventing waviness present in an outer peripheral area on a surface of a disk even if the wall is thin.

### Means for Solving the Problems

As a result of diligent study and discussion, the present inventors have found that a substrate for a magnetic disk is prevented from causing waviness in the outer peripheral area and is prevented from causing a head crash when it has a small arithmetic mean height Sa in an outer peripheral area at least on one surface, and have completed the present invention.

To achieve the object described above, the gist configuration of the present invention is as follows.
(1) A substrate for a magnetic disk, having a maximum value of arithmetic mean heights Sa of 0.50 nm or less and a standard deviation of the arithmetic mean heights Sa of 0.10 nm or less, wherein the arithmetic mean heights Sa are defined by ISO25178 and are each measured in a plurality of field-of-view areas positioned in an outer peripheral area on at least one surface using scanning optical interferometry in a middle wavelength region through a Gaussian filter with a cutoff wavelength of 1.0 mm.
(2) The substrate for a magnetic disk as described in (1), in which a mean value of the arithmetic mean heights Sa is 0.40 nm or less.
(3) The substrate for a magnetic disk as described in (1) or (2), in which a thickness dimension is less than 0.50 mm.
(4) The substrate for a magnetic disk as described in any one of (1) to (3), in which an outer diameter dimension is 95 mm or more.
(5) A magnetic disk, having a maximum value of arithmetic mean heights Sa of 0.50 nm or less and a standard deviation of the arithmetic mean heights Sa of 0.10 nm or less, wherein the arithmetic mean heights Sa are defined by ISO25178 and are each measured in a plurality of field-of-view areas positioned in an outer peripheral area on at least one surface using scanning optical interferometry in a middle wavelength region through a Gaussian filter with a cutoff wavelength of 1.0 mm.

The present invention provides a substrate for a magnetic disk that effectively prevents occurrence of a head crash by effectively preventing waviness present in an outer peripheral area on a surface of a disk even if the wall is thin.

### BRIEF DESCRIPTION OF THE DRAWINGS

FIG. 1 is a top view of a substrate for a magnetic disk according to the present invention, and shows an example of an outer peripheral area on the upper surface, and a plurality of field-of-view areas where an arithmetic mean heights Sa are measured;

FIG. 2 is a flowchart showing an example of a step of manufacturing an aluminum alloy substrate for a magnetic disk according to the present invention; and

FIG. 3 is a flowchart showing an example of a step of manufacturing a glass substrate for a magnetic disk according to the present invention.

### PREFERRED MODE FOR CARRYING OUT THE INVENTION

Hereinafter, a substrate for a magnetic disk according to the present invention is described in detail.

The substrate for a magnetic disk in the present invention is a substrate for a magnetic disk where the maximum value of the arithmetic mean heights Sa is 0.50 nm or less, and in particular, the standard deviation of the arithmetic mean heights Sa is 0.10 nm or less, when the arithmetic mean heights Sa are defined by ISO25178 and are each measured in a plurality of field-of-view areas positioned in an outer peripheral area on at least one surface using scanning optical interferometry in a middle wavelength region through a Gaussian filter with a cutoff wavelength of 1.0 mm.

### <Arithmetic Mean Height Sa>

The “arithmetic mean height Sa specified by ISO25178” is the arithmetic mean of the absolute values of the differences of heights at points with respect to an average surface on the surface of the substrate. In other words, it is a three-dimensional arithmetic average height, and is regarded as a typical evaluation indicator for the surface roughness. Note that the contour curves of the substrate surface are classified into a waviness curve having a long wavelength, and a roughness curve having a short wavelength. The “cutoff wavelength” is a wavelength serving as a threshold suitable for only detecting (extracting) a contour curve (e.g., the waviness curve) in a wavelength region intended to be detected, but not detecting the other contour curves (e.g., the roughness curve). For example, a minute waviness component can be solely evaluated by removing the irregular component away from the cutoff wavelength on a shorter wavelength side, together with a larger waviness component on a longer wavelength side through the Gaussian filter, i.e., by measuring in a middle wavelength region centered at the cutoff wavelength of 1.0 mm.

The present inventors have found this time that with a substrate with a reduced thickness, the waviness including minute irregularities in the outer peripheral area of a disk, i.e., a so-called wavy surface defect, sometimes serves as a cause of a head crash. Although various measures for preventing a head crash of a hard disk have been discussed, the adverse effect of the wavy surface defect on a head crash has not been discussed yet.

Furthermore, the present inventors have found that the wavy surface defect is a defect of waviness mainly over a several-millimeter width range, it is appropriate for the detection to remove the minute irregularities on the short wavelength range away from the cutoff wavelength of 1.0 mm, together with the large waviness component on the long wavelength side. For the detection, a contour curve in a middle wavelength region may be detected through a Gaussian filter with a cutoff wavelength of 1.0 mm. By measuring Sa in a plurality of field-of-view areas positioned in the outer peripheral area on at least one surface of the substrate in the wavelength region centered at 1.0 mm as described above, the wavy surface defect that can serve as a cause of a head crash can be sensitively detected. Under such conditions, Sa in the outer peripheral area can be measured using scanning optical interferometry, and a substrate for a magnetic disk where the maximum value of Sa is 0.50 nm or less, in particular, a substrate for a magnetic disk where the standard deviation of Sa is 0.10 nm or less, can prevent occurrence of a head crash.

### (Outer Peripheral Area)

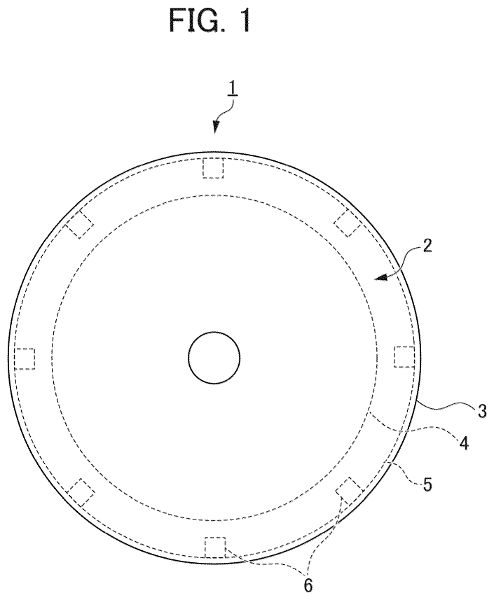

The outer peripheral area on the substrate for a magnetic disk indicates an area surrounded by the outer peripheral edge of the substrate for a magnetic disk, and a virtual circle defined on the inner peripheral side from the outer peripheral edge by several millimeters. FIG. 1 shows an example of an outer peripheral area 2 on an upper surface of a substrate for a magnetic disk 1 according to the present invention. The outer peripheral area 2 indicates an area surrounded by an outer peripheral edge 3 of the substrate for a magnetic disk 1, and a virtual inner circle 4 drawn as a concentric circle closer to the center than the outer peripheral edge 3 by several millimeters, in top view of the substrate for a magnetic disk 1. Hereinafter, arithmetic mean heights Sa measured in a plurality of field-of-view areas positioned in the outer peripheral area 2 are sometimes called “Sa in the outer peripheral area”.

The outer peripheral area can be considered as a site where a head crash occurs most frequently during use of the magnetic disk. This is because the magnetic disk is subjected to a centrifugal force and further to an external force such as an air resistance force due to the ambient atmosphere and gas by rotation, and a site where vibrations and waviness (fluttering) occur due to the external force is the outer peripheral area of the magnetic disk in this case. The wavy surface defect in this area causes fluttering, which possibly serves as a cause of a head crash as a result. Consequently, the outer peripheral area on the surface of the substrate for a magnetic disk, which forms the magnetic disk, is the principal part to prevent fluttering. The present inventors have found for the first time that the fluttering can be prevented and the risk of a head crash can be reduced by focusing on Sa in the outer peripheral area.

### (Field-of-View Area)

In the substrate for a magnetic disk 1, the plurality of field-of-view areas that are measurement sites for Sa in the outer peripheral area may be two areas or more in the outer peripheral area 2. The number of areas is not specifically limited. In view of securing the reliability, it is preferable that the number of field-of-view areas should be three or more, for example, four or more. In view of simplicity of the product test, for example, it is preferable that the number should be 16 or less. More preferably, the maximum value is adopted among arithmetic mean heights Sa measured in 6 to 12 field-of-view areas, for example, 8 areas.

The plurality of field-of-view areas may be disposed anywhere in the outer peripheral area 2. However, to measure Sa on the outer peripheral side as evenly as possible, it is preferable that the field-of-view areas should be evenly disposed to be internal contact with the inside of the virtual outer circle 5 drawn on the slightly closer to the center than the outer peripheral edge 3 of the substrate for a magnetic disk. For example, as shown in FIG. 1, in a case where the eight field-of-view areas 6 are disposed at positions at 0°, 45°, 90°, 135°, 180°, 225°, 270°, and 315° in a state with the corners of the squares being in contact with the inner periphery of the virtual outer circle 5, Sa in the outer peripheral area 2 can be more accurately measured. Preferably, the virtual outer circle 5 is a concentric circle closer to the center than the outer peripheral edge 3 of the substrate for a magnetic disk by about 0.1 to 1 mm, for example, closer to the center by about 0.5 mm.

The size of the field-of-view area 6 is not specifically limited either. In view of reliability, it is preferable to perform measurement in the field-of-view areas that are as large as possible. However, in consideration of the convenience during measurement, the characteristics of the measurement instrument and the like, it is preferable that areas of squares with a side of 4 to 6 mm, in particular, squares with a side of 4.5 to 5.0 mm should be employed as the field-of-view areas 6. For example, eight square areas with a side of 4.75 mm arranged as shown in FIG. 1 are employed as the field-of-view areas 6 to measure values through scanning optical interferometry, thus allowing Sa in the outer peripheral area of the substrate for a magnetic disk 1 to be accurately reflected.

### (Scanning Optical Interferometry)

The scanning optical interferometry is a typical method for measuring a three-dimensional shape and the like. This method causes a beam splitter to split light emitted from a light source into two beams, emits one toward a reference surface and emits the other toward a sample surface, and focuses light beams reflected by both the surfaces in a camera. Furthermore, information on an interference pattern obtained from an optical path difference caused by irregularities on the sample surface is converted into height information, thus forming a three-dimensional shape. Measurement instruments based on scanning optical interferometry are provided by multiple companies and available in the market, and any one of these products available in the market may be used in the present invention.

### (Sa Value)

The risk of a head crash can be reduced with a magnetic disk where the maximum value of the arithmetic mean heights Sa specified by ISO25178 measured using scanning optical interferometry, in a middle wavelength area through a Gaussian filter with a cutoff wavelength of 1.0 mm, in a plurality of field-of-view areas positioned in the outer peripheral area on at least one surface is 0.50 nm or less. In view of further reducing the risk of a head crash, it is preferable that the maximum value of Sa in the outer peripheral area should be 0.40 nm or less, in particular, 0.30 nm or less. Note that the smaller Sa in the outer peripheral area is, the more preferable it is. Accordingly, there is no need to consider the lower limit value. However, in consideration of simplicity in the manufacturing step, for example, the lower limit value may be 0.20 nm or 0.15 nm.

Preferably, the mean value of the arithmetic mean heights Sa (Sa in the outer peripheral area) in the respective field-of-view areas in the outer peripheral area is herein 0.40 nm or less, in particular, 0.30 nm or less. Likewise, the smaller the mean value of Sa, the more preferable it is. However, also in consideration of simplicity in the manufacturing step, for example, the lower limit value may be 0.20 nm or 0.25 nm. The substrate for a magnetic disk where the maximum value of Sa in the outer peripheral area is 0.50 nm or less, and the mean value of the Sa is 0.40 nm or less has a significantly flat surface, and a more reduced risk of a head crash.

The substrate for a magnetic disk is preferable where the standard deviation of arithmetic mean heights Sa in the respective field-of-view areas in the outer peripheral area is 0.10 nm or less. Such a substrate for a magnetic disk has Sa with a low value evenly at each site on the substrate, and has a particularly smooth surface. Accordingly, the risk of a head crash is further reduced. Note that each of the standard deviation here and the mean value described above is a value calculated from the arithmetic mean heights Sa used to obtain the maximum value.

In particular, with the substrate for a magnetic disk, it is preferable that the maximum value of the arithmetic mean heights Sa measured in the field-of-view areas positioned in the outer peripheral areas on the opposite surfaces of the substrate should be 0.50 nm or less. In the case where the opposite surfaces are flat as described above, the substrate for a magnetic disk is particularly resistant to occurrence of a head crash. Because of the same reason, it is preferable that the mean value of Sa in the field-of-view areas positioned in the outer peripheral areas on the opposite surfaces of the substrate should be 0.40 nm or less, and/or the standard deviation should be 0.10 nm or less.

A substrate that constitutes such a substrate for a magnetic disk is described below.

### <Substrate>

The substrate for a magnetic disk according to the present invention may be formed of any of publicly known substrates. The size and material are not specifically limited. However, the advantageous effects of the present invention are significant particularly in a thin-wall substrate for a magnetic disk with a thickness dimension of less than 0.5 mm. Such a thin-wall substrate has a low stiffness and accordingly, a large surface height Sa in the outer peripheral area largely affects the reliability of the hard disk. For the similar reason, the advantageous effects of the present invention are significant for a substrate for a magnetic disk having an outer diameter dimension of 95 mm or more. Note that there is no limitation to the upper limit value of the external dimension. However, in consideration of a typical size of a hard disk drive, for example, the value may be 97 mm or less. There is also no limitation to the lower limit value of the thickness dimension. However, in consideration of the stiffness of a magnetic disk, for example, the value may be about 0.30 mm or greater.

The material of the substrate for a magnetic disk according to the present invention can be appropriately selected from among materials having been conventionally used, and may be, for example, an aluminum alloy, glass, etc. The substrate for a magnetic disk made of any of an aluminum alloy, glass and the like is resistant to any failure, and has favorable mechanical properties and workability. Accordingly, the substrate is suitable for the substrate for a magnetic disk according to the present invention.

### <Aluminum Alloy Substrate>

The substrate made of an aluminum alloy (sometimes simply called “aluminum alloy substrate” in Description of the present application) is resistant to any failure, the mechanical property and workability are favorable, and the cost is low. Accordingly, the substrate is suitable for a substrate for a magnetic disk. The material of the aluminum alloy substrate is not specifically limited either and various publicly known materials can be used. However, a conventionally used alloy containing an element, such as magnesium (Mg), copper (Cu), zinc (Zn), or chromium (Cr) is preferable. Such alloys have a low cost because they are conventional materials, and further have the advantages of high strength and strong resistance to failure. An element, such as iron (Fe), manganese (Mn), nickel (Ni) that can improve the stiffness can be contained. Such a substrate with high stiffness is advantageous in preventing fluttering. More preferably, any of alloys of A5000s or A8000s, in particular, A5086 should be used. With such an alloy, the substrate is resistant to any failure, and can be provided with sufficient mechanical characteristics.

Examples of the specific composition of the aluminum alloy include, for example, A5086 that contains Mg: 3.5 to 4.5%, Fe: 0.50% or less, Si: 0.40% or less, Mn: 0.20 to 0.7%, Cr: 0.05 to 0.25%, Cu: 0.10% or less, Ti: 0.15% or less, and Zn: 0.25% or less, and the remaining parts made of Al and unavoidable impurities. A specific example of another composition of an aluminum alloy includes Mg: 1.0 to 6.5%, Cu: 0 to 0.070%, Zn: 0 to 0.60%, Fe: 0 to 0.50%, Si: 0 to 0.50%, Cr: 0 to 0.20%, Mn: 0 to 0.50%, Zr: 0 to 0.20%, and Be: 0 to 0.0020%, and the remaining parts made of aluminum and unavoidable impurities. Furthermore, for example, 0.1% or less of a component other than the components described above may be contained with respect to each element, with total 0.3% or less of the components contained. Note that for the compositions described above, every “%” means “% by mass”.

### <Glass Substrate>

The glass substrate is resistant to any failure, and has characteristics of favorable mechanical properties and workability, and advantages of being resistant to plastic deformation. Accordingly, the glass substrate is suitable for the substrate for a magnetic disk. The material is not specifically limited either. Glass ceramics, such as amorphous glass and crystallized glass can be used. Note that in view of the planar level, formability, and workability of the substrate, it is preferable to use amorphous glass. The material is not specifically limited. Examples of the material include aluminosilicate glass (aluminosilicate glass), soda-lime glass, soda-aluminosilicate glass, aluminoborosilicate glass, borosilicate glass (borosilicic acid glass), and further include physically strengthened glass, chemically strengthened glass and the like that have been subjected to a treatment, such as of air cooling or liquid cooling. However, there is no limitation thereto. Among them, aluminosilicate glass, in particular, amorphous aluminosilicate glass is preferable. A substrate made of such a material is excellent in the planar level and strength, and the long-term reliability can also be favorable.

For example, aluminosilicate glass that contains SiO₂: 55 to 75% as principal component, and contains Al₂O₃: 0.7 to 25%, Li₂O: 0.01 to 6%, Na₂O: 0.7 to 12%, K₂O: 0 to 8%, MgO: 0 to 7%, CaO: 0 to 10%, ZrO₂: 0 to 10%, and TiO₂: 0 to 1% has been known. The present invention can use a substrate made of such a material. Note that for the compositions described above and below, every “%” means “% by mass”.

In the glass composition described above, SiO₂ is a main component forming a framework of glass. If the content is 55% or more, high chemical durability tends to occur. If the content is 75% or less, there is a tendency that the melting temperature is not too high, and forming is facilitated.

Al₂O₃ is a component having an effect of improving the ion-exchange capability and the chemical durability. To exert such an effect, it is preferable that Al₂O₃ content is 0.7% or more. If the Al₂O₃ content is 25% or less, there is no possibility of degradation of the solubility and the devitrification resistance. Accordingly, it is preferable that Al₂O₃ content ranges from 0.7 to 25%.

Li₂O is a component having effects of ion-exchange with Na ions and chemically strengthening glass, improving the fusibility and formability, and improving the Young's modulus. To exert such effects, it is preferable that the Li₂O content is 0.01% or more. If the Li₂O content is 6% or less, there is no possibility of reducing the devitrification resistance and the chemical durability. Accordingly, it is preferable that the Al₂O₃ content ranges from 0.01 to 6%.

Na₂O is a component having effects of ion-exchange with K ions and chemically strengthening glass, reducing the high-temperature viscosity, improving the fusibility and formability, and improving the devitrification resistance. To exert such effects are exerted, it is preferable that the Na₂O is 0.7% or more. If the Na₂O content is 12% or less, it is preferable because there is no possibility of reducing the chemical durability and the Knoop hardness number.

Furthermore, K₂O, MgO, CaO, ZrO₂, and TiO₂ are optionally, additional components, which can be contained as needed.

K₂O is a component having effects of reducing the high-temperature viscosity, improving the fusibility, formability, and devitrification resistance. However, if the K₂O content exceeds 8%, there is a tendency that the low-temperature viscosity decreases, the thermal expansion coefficient increases, and the shock resistance decreases. Accordingly, it is preferable that the K₂O content ranges from 0 to 8%.

MgO and CaO are components having effects of reducing the high-temperature viscosity, improving the solubility, clarity, and formability, and improving the Young's modulus. In particular, CaO is contained as an essential component in soda-lime glass. Here, MgO and CaO are expected to have effects of reducing the high-temperature viscosity, improving the solubility, clarity, and formability, and improving the Young's modulus. If the MgO content exceeds 7% and/or the CaO content exceeds 10%, the ion-exchange performance and the devitrification resistance tend to decrease. Accordingly, it is preferable that the MgO content is 7% or less, and the CaO content is 10% or less.

ZrO₂ is a component having effects of increasing the Knoop hardness number, and improving the chemical durability and the heat resistance. However, if the ZrO₂ content exceeds 10%, the fusibility and the devitrification resistance tend to decrease. Accordingly, it is preferable that the ZrO₂ content ranges from 0 to 10%.

TiO₂ is a component having effects of reducing the high-temperature viscosity, improving the fusibility, stabilizing the structure, and improving the durability. However, if the TiO₂ content exceeds 1%, the ion-exchange performance and the devitrification resistance tend to decrease. Accordingly, it is preferable that the TiO₂ content ranges from 0 to 1%.

The glass having the composition described above may further include not only B₂O₃ having effects of reducing the viscosity, and improving the solubility and clarity, SrO or BaO having effects of reducing the high-temperature viscosity, improving the solubility, clarity, and formability, and improving the Young's modulus, ZnO that can improve the ion-exchange performance, and reduce the high-temperature viscosity without reducing the low-temperature viscosity, SnO₂ having effects of improving the clarity and the ion-exchange performance, and Fe₂O₃ that can function as a colorant, but also As₂O₃ and Sb₂O₃ as clarifying agents. Furthermore, oxides, such as lanthanum (La), phosphorus (P), cerium (Ce), antimony (Sb), hafnium (Hf), rubidium (Rb), and yttrium (Y) may be contained as trace elements. Note that B₂O₃ is contained as an essential component in alumino-borosilicate glass, and borosilicate glass.

The glass may have a composition that contains SiO₂: 45 to 60%, Al₂O₃: 7 to 20%, B₂O₃: 1 to 8%, P₂O₅: 0.5 to 7%, CaO: 0 to 3%, TiO₂: 1 to 15%, BaO: 0 to 4%, and another oxide, such as MgO: 5 to 35%.

### <Method for Manufacturing Aluminum Alloy Substrate>

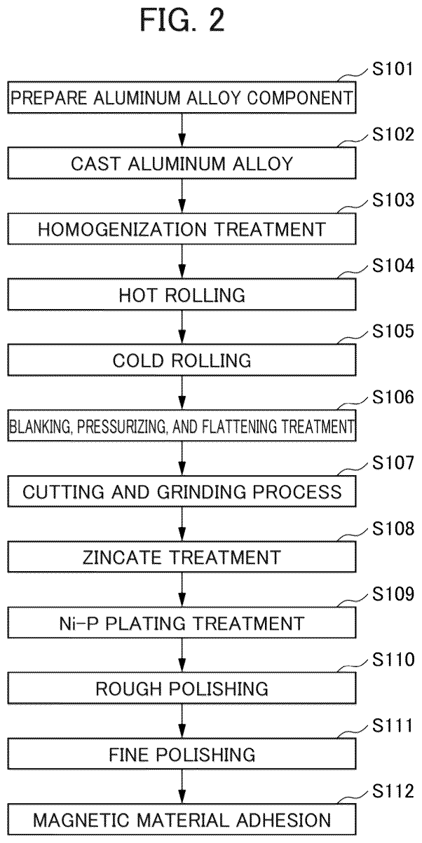

FIG. 2 is a flowchart showing an example of a step of manufacturing an aluminum alloy substrate for a magnetic disk according to the present invention. In FIG. 2, an aluminum alloy component preparing step (step S101), an aluminum alloy casting step (step S102), a homogenization treatment step (step S103), a hot rolling step (step S104), and cold rolling (step S105) are steps of manufacturing an aluminum alloy material through melt casting, and forming an aluminum alloy plate from this material. Next, by a blanking, pressurizing, and flattening treatment step (step S106), a disk blank made of an aluminum alloy is manufactured. A pretreatment, such as a cutting process and grinding process step (step S107), is applied to the manufactured disk blank, and an annular aluminum alloy plate is fabricated. A zincate treatment step (step S108), and an electroless Ni—P plating treatment step (step S109) are applied to the substrate, and an aluminum alloy substrate for a magnetic disk is fabricated. The manufactured aluminum alloy substrate (blank substrate) for a magnetic disk is subjected to a rough polishing step (step S110), and a fine polishing step (step S111), and is made as a magnetic disk through a magnetic material adhesion step (step S112).

Hereinafter, according to the flow of FIG. 2, the content of each step is described in detail.

First, a molten metal of the aluminum alloy material having the component composition described above is prepared by heating and melting according to a common procedure (step S101). Next, the prepared molten metal of aluminum alloy material is casted according to a semi-continuous casting (DC casting) method, a continuous casting (CC casting) method or the like, thus casting the aluminum alloy material (step S102). In particular, vertical semi-continuous casting is preferable. In the DC casting method and the CC casting method, an aluminum alloy material manufacturing condition and the like are as follows.

According to the DC casting method, the molten metal poured through a spout is deprived of heat by a bottom block, a water-cooled mold wall, and cooling water directly discharged to the periphery of an ingot, set, and drawn below as an aluminum alloy ingot.

On the other hand, according to the CC casting method, a casting nozzle is inserted between a pair of rolls (or a belt caster, or a block caster), a molten metal is supplied, and heat is removed from the rolls, thus directly casting an aluminum alloy thin-plate.

The DC casting method and the CC casting method are largely different in the cooling rate in casting. The CC casting method with a higher cooling rate is characterized in that secondary phase particles have a smaller size than in DC casting.

The homogenization treatment is applied to a DC-cast aluminum alloy ingot as needed (step S103). When the homogenization treatment is applied, it is preferable to perform a heating treatment at 280° C. to 620° C. for 0.5 to 30 hours, and it is more preferable to perform a heating treatment at 300° C. to 620° C. for 1 to 24 hours. If the heating temperature of the homogenization treatment is less than 280° C. or the heating time period is less than 0.5 hours, there is a possibility that the homogenization treatment is insufficient, and the loss factor largely varies among individual aluminum alloy plates. If the heating temperature in the homogenization treatment exceeds 620° C., the aluminum alloy ingot is possibly melted. Even if the heating time period of the homogenization treatment exceeds 30 hours, the advantageous effect is saturated, and any further significant improvement effect cannot be achieved.

Next, a (DC-cast) aluminum alloy ingot having been subjected to the homogenization treatment as needed or to no homogenization treatment is hot-rolled, and is formed as a plate (step S104). The condition for the hot rolling is not specifically limited. However, it is preferable that the hot rolling start temperature ranges from 250° C. to 600° C., and the hot rolling end temperature from 230° C. to 450° C.

Next, a hot-rolled sheet, or a cast plate cast by the CC casting method is cold-rolled, and is formed as an aluminum alloy plate with, for example, about 0.30 to 0.60 mm (step S105). The cold rolling condition is not specifically limited, and may be defined depending on a required product plate strength and plate thickness (thickness dimension). Preferably, the rolling ratio ranges from 10% to 95%.

Note that it is preferable to apply an annealing treatment in order to secure cold rolling workability before the cold rolling or in the cold rolling. It is preferable that the temperature of the annealing treatment ranges from 250° C. to 500° C., in particular, from 300° C. to 450° C. By applying the annealing treatment in such a condition, deformation unlikely occurs even in long-term use, and a favorable planar level can be held. More specific annealing condition can be, for example, holding at 300° C. to 450° C. for 0.1 to 10 hours in a batch-type heating, or holding at 400° C. to 500° C. for 0 to 60 seconds in the continuous-type heating. Here, a holding time of 0 seconds means cooling immediately after a desired holding temperature is reached.

The aluminum alloy plate obtained by cold rolling is punched into an annular shape, and thus an annular aluminum alloy plate is formed. Preferably, the annular aluminum alloy plate is formed as a disk blank by the blanking, pressurizing, and flattening treatment (step S106). Preferably, the blanking, pressurizing, and flattening treatment (also called “press annealing”) is performed at a temperature of the recrystallization temperature of the aluminum alloy or higher with an applied pressure of about 30 to 60 kg/cm². For example, in the atmosphere, a temperature of 250° C. to 500° C., in particular, 300° C. to 400° C. is held for about 0.5 to 10 hours, in particular, about 1 to 5 hours, thus fabricating a flattened blank.

The disk blank is subjected to the cutting process and grinding process (step S107), and the heating treatment as needed, before the subsequent zincate treatment. Preferably, before an after-mentioned polishing step, in particular, before a rough polishing step, dummy polishing is performed to manage the surface of the polishing pad.

Next, the surface of the disk blank is degreased, etched, and is subjected to the zincate treatment (Zn-substituting treatment) (step S108). The degreasing can be performed using, for example, the commercially available degreasing solution AD-68F (made by C.Uyemura & Co., Ltd.) or the like under the condition at a concentration of 200 to 800 mL/L at a temperature of 40° C. to 70° C. for a treatment time period of 3 to 10 minutes. The etching may be performed by acid etching using the commercially available AD-107F (made by C.Uyemura & Co., Ltd.) etching solution under the condition at a concentration 20 to 100 mL/L at a temperature of 50° C. to 75° C. for a treatment time period of 0.5 to 5 minutes. In the zincate treatment, a zincate film is formed on the surface of the disk blank. The zincate treatment can use a commercially available zincate treatment solution. Preferably, the treatment is performed under the condition at a concentration of 100 to 500 mL/L at a temperature of 10° C. to 35° C. for a treatment time period of 0.1 to 5 minutes. The zincate treatment is performed at least once, and may be performed twice or more. By performing the zincate treatment multiple times, Zn is finely deposited, and a uniform zincate film can be formed.

In a case of performing the zincate treatment twice or more, a Zn peeling treatment may be performed. Preferably, the Zn peeling treatment is performed using HNO₃ solution under the condition at a concentration of 10 to 60% at a temperature of 15° C. to 40° C. for a treatment time period of 10 to 120 seconds (accordingly, also called “nitric acid peeling treatment”). Preferably, the second and subsequent zincate treatments are executed under the condition similar to that of the first zincate treatment.

Furthermore, for example, the electroless Ni—P plating treatment (step S109) is applied, as a base treatment for magnetic material adhesion, to the surface of the zincate treated disk blank. Preferably, the electroless Ni—P plating treatment step is performed using a commercially available solution, e.g., NIMUDEN® HDX made by C.Uyemura & Co., Ltd., under the condition at an Ni concentration: 3 to 10 g/L at a temperature: 80° C. to 95° C. for a treatment time period: 30 to 180 minutes.

The plating surface after the electroless Ni—P plating treatment is subjected to a polishing treatment (steps S110 to S111) as described later, and a substrate for a magnetic disk is obtained. A magnetic material is caused to adhere to the substrate (step S112), and is stacked as required, and thus a magnetic disk, such as a hard disk, can be manufactured. The magnetic material adhesion may be performed by, for example, sputtering or the like.

Note that Sa in the outer peripheral area may be measured for a substrate for a magnetic disk before magnetic material adhesion. However, it may be measured after the magnetic material adhesion as described later. This is because the magnetic material is sufficiently thin, and does not affect the numerical value of Sa in the outer peripheral area.

### <Method for Manufacturing Glass Substrate>

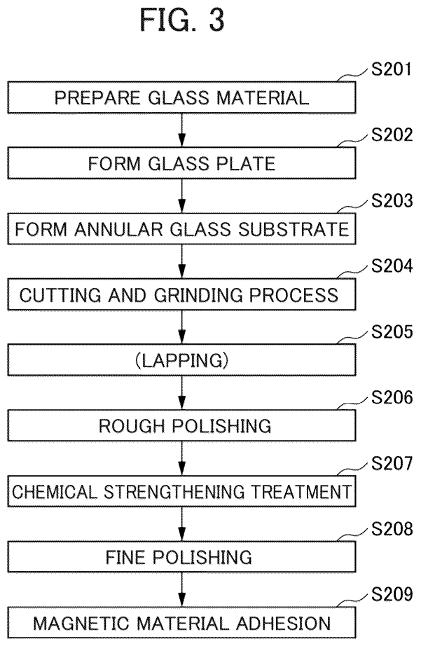

FIG. 3 is a flowchart showing an example of a step of manufacturing a glass substrate for a magnetic disk according to the present invention. First, a glass plate having a predetermined thickness is prepared (steps S201 and S202). Next, the prepared glass plate is subjected to coring, and an end face polishing process is applied to the inner and outer peripheries, thus forming and processing an annular glass substrate (steps S203 and S204). Next, the formed glass substrate is subjected to lapping (step S205) using diamond pellets or the like, as required. Subsequently, or after step S204, a rough polishing step of integrally clamping the glass substrates from the top and bottom with polishing pads, and simultaneously polishing the glass substrates with, for example, cerium oxide abrasive grains is performed (step S206), and after a chemical strengthening treatment (step S207) is applied as required, a fine polishing step (step S208) with, for example, colloidal silica abrasive grains is performed. Next, a magnetic disk is manufactured by a magnetic material adhesion step (step S209).

Hereinafter, according to the flow of FIG. 3, the content of each step is specifically described.

First, a melt of the glass material having the component composition described above is prepared by heating and melting according to a common procedure (step S201). Next, the prepared melt of the glass material is formed into a glass plate by a publicly known manufacturing method, such as the float method, down draw method, direct pressing method, redraw method, or fusion method (step S202). Here, it is preferable to use the redraw method of heating and softening a base glass plate manufactured using the float method or the like and of drawing the plate to have a desired thickness because a glass plate having a small variation in thickness can be relatively easily manufactured.

Next, an annular glass substrate is formed by the coring step from the glass plate obtained in step S202 (step S203). By the cutting and grinding process (step S204), the end faces of inner and outer peripheries may be polished. The formed glass substrate (glass blank) becomes an annular plate that has two main surface planes, and a circular hole formed at the center.

An annealing treatment (anneal treatment) may be applied to the obtained glass blank. For example, the annealing treatment can be performed by holding the glass blank at a temperature around the strain point for about 15 minutes or more, and gradually cooling for about 3 to 12 hours. Preferably, the temperature of the annealing treatment ranges from 250° C. to 750° C., in particular, from 500° C. to 700° C., depending on the glass material. By applying the annealing treatment in such a condition, deformation unlikely occurs even in long-term use, and a favorable planar level can be held. More specific annealing condition can be, for example, holding at 500° C. to 650° C. for 0.1 to 10 hours in a batch-type heating, or holding at 500° C. to 750° C. for 0 to 60 seconds in the continuous-type heating. Here, a holding time of 0 seconds means cooling immediately after a desired holding temperature is reached. For example, the glass substrate according to the present invention can be manufactured by forming the commercially available glass plate having the composition as described above into an annular shape and applying the annealing treatment.

Next, in step S205, the lapping process is optionally applied to the formed annular plate, thus adjusting the plate thickness. Note that depending on the plate thickness of the glass substrate obtained in the processes up to step S204, the lapping step S205 may be omitted, and the process may proceed to the following polishing step. For example, typically, the glass plate manufactured by the redraw method has a small variation in thickness. Accordingly, the lapping step S205 is not required to be executed. If the glass plate is manufactured by the float method or the direct pressing method, it is desirable to perform the lapping step S205. The lapping process can be executed using, for example, a batch-type double-sided polisher that uses diamond pellets.

The following polishing treatment (steps S206 to S208) is applied to the glass substrate (blank substrate) obtained as described above, and the substrate for a magnetic disk is thus obtained. A magnetic material is caused to adhere to the substrate (step S209), and is stacked as required, and a magnetic disk, such as a hard disk, can be manufactured.

Preferably, in the polishing treatment described above, between the rough polishing (step S206) and the fine polishing (step S208), the chemical strengthening treatment (step S207) is applied to the glass substrate. By chemical strengthening, lithium ions and sodium ions on the surface layer of the glass substrate are substituted respectively with sodium ions and potassium ions that have relatively large ion diameters in a chemically strengthening liquid. As a result, a compressive stress layer is formed in the surface layer portion, thus allowing the glass substrate to be strengthened. The chemical strengthening treatment method is not specifically limited, and for example, can be performed by soaking the glass substrate in the chemically strengthening liquid heated to 300° C. to 400° C. for about 3 to 4 hours. Here, the chemically strengthening liquid is not specifically limited either. For example, a mixture of potassium nitrate (60 weight percent) and sodium sulfate (40 weight percent) or the like can be used. Preferably, the glass substrate is cleaned before the chemical strengthening treatment, and is preheated to about 200° C. to 300° C. Preferably, the chemically strengthened glass substrate is subjected to a cleaning treatment. For example, after cleaning with an acid, such as sulfuric acid, cleaning may be further performed with pure water or the like.

### <Polishing Treatment>

Typically, the substrate for a magnetic disk is subjected to the polishing treatment for flattening before magnetic material adhesion, regardless of the material of the substrate. Preferably, in this polishing step, polishing in multiple stages is performed with the diameters of the polishing abrasive grains being adjusted. Typically, it is preferable to perform rough polishing and fine polishing using a double-sided simultaneous polisher. The substrate for a magnetic disk according to the present invention can also be polished using a commercially available double-sided simultaneous polisher. Preferably, before the rough polishing, dummy polishing is performed, and the surfaces of the polishing pads are controlled.

### (Double-Sided Polisher)

Typically, the double-sided simultaneous polisher includes: an upper surface plate and a lower surface plate that are made of cast iron; a carrier that holds a plurality of substrates between the upper surface plate and the lower surface plate; and polishing pads attached respectively to substrate contact surfaces of the upper surface plate and the lower surface plate. Typically, in the polishing treatment, the substrates are held between the upper surface plate and the lower surface plate by the carrier, and each substrate is clamped at a predetermined processing pressure by the upper surface plate and the lower surface plate. Each substrate is integrally clamped from the top and bottom with polishing pads. Next, while a polishing liquid is being supplied between the polishing pads and the individual substrates at a predetermined supply rate, the upper surface plate and the lower surface plate are rotated in different directions. At this time, the carrier also rotates on its own axis by a sun gear. Accordingly, the substrates perform planetary motions. Accordingly, each substrate is slid on the surfaces of the polishing pads, and both the surfaces are simultaneously polished.

The details of the type and structure of the double-sided polisher are not specifically limited. Any of commercially available devices may be used. Here, preferably, in the double-sided polisher, the thickness dimension of the carrier that holds the substrate is smaller than the thickness dimension of the substrate by 0.05 to 0.15 mm, in particular, more preferably, smaller by 0.07 to 0.12 mm. With such a carrier, a disk that has the maximum value of Sa equal to or less than 0.50 nm, in particular, the mean value of Sa equal to or less than 0.4 nm, in the outer peripheral area can be more securely manufactured. Since a site with large Sa often occurs mainly in the rough polishing step, it is preferable that in particular, the thickness dimension of the carrier used in the rough polishing step in the polisher should be less than the thickness dimension of the substrate by 0.05 mm to 0.15 mm.

### (Rough Polishing)

The rough polishing treatment method is not specifically limited, and can be performed under any condition depending on the material of the substrate. For example, the rough polishing of the aluminum alloy plate can be performed using a polishing liquid containing alumina with particle diameters of 0.1 to 1.0 μm, and polishing pads made of hard or soft polyurethane or the like. The rough polishing of the glass substrate can be performed using a polishing liquid containing cerium oxide with particle diameters of 0.1 to 1.0 μm, and polishing pads made of hard polyurethane or the like. However, the condition for the rough polishing treatment is not limited to them. A desired one can be selected from among publicly known polishing treatment conditions. For example, instead of alumina and cerium oxide described above, abrasive grains made of silica, zirconium oxide, SiC, diamond or the like with a desired particle diameter may be used. Note that the hard property has a hardness (Asker-C) of 85 or higher measured by a measurement method defined by The Society of Rubber Industry, Japan Standard (compliance standard: SRIS0101), and the soft property has a hardness ranging from 60 to 80.

A specific rough polishing condition is affected also by the material of the adopted substrate and by steps to application of the rough polishing (e.g., steps S101 to S109 in manufacturing of the aluminum alloy substrate, and steps S201 to S205 in manufacturing of the glass substrate), and is difficult to be uniquely defined. There is no limitation to any specific condition. For example, the rough polishing condition for the aluminum alloy substrate may be a polishing time period ranging from 2 to 5 minutes, a polishing surface plate rotational speed ranging from 10 to 35 rpm, a sun gear rotational speed ranging from 5 to 15 rpm, a polishing liquid supply rate ranging from 1000 to 5000 mL/min., a processing pressure ranging from 20 to 250 g/cm², preferably, from 20 to 150 g/cm², more preferably, from 60 to 120 g/cm², and a polishing amount ranging from 2.5 to 3.5 μm.

The rough polishing condition for the glass substrate is not specifically limited either. Preferably, for example, hard polishing pads having a hardness of 86 to 88 are used, the polishing surface plate rotational speed ranges from 10 to 35 rpm, the sun gear rotational speed ranges from 5 to 15 rpm, the polishing liquid supply rate ranges from 1000 to 5000 mL/min., the processing pressure ranges from 20 to 250 g/cm², preferably, from 20 to 150 g/cm², and more preferably, from 60 to 120 g/cm², and the polishing time period ranges from 2 to 10 minutes.

### (Dummy Polishing)

Preferably, in the polishing treatment, dummy polishing is performed and the surfaces of the polishing pads are controlled before the rough polishing as described above. Typically, the dummy polishing step is performed as in the rough polishing step, preferably under the same conditions thereof using a dummy substrate. The dummy substrate to be used is not specifically limited. For example, before the rough polishing of the glass substrate, dummy polishing can be performed using the aluminum alloy substrate. It is preferable to use a blank substrate of the same type as that for a product, in particular, a blank substrate manufactured under the conditions similar to those of a blank substrate for a product. In the dummy polishing step according to the present invention, the dummy substrate may be polished until the arithmetic mean waviness Wa through measurement in a long-wavelength region with a cutoff wavelength of 0.4 to 5.0 mm becomes less than 2.5 nm, for example, thus managing the surface of the polishing pad surface.

The present inventors have found that Sa in the outer peripheral area is correlated with the arithmetic mean waviness Wa, and a substrate for a magnetic disk with the maximum value in the outer peripheral area less than or equal to 0.50 nm can be manufactured using the polishing pad managed with reference to Wa. The arithmetic mean waviness Wa in the dummy polishing step can be measured by a conventional method. For example, one of the main surfaces of the dummy substrate may be entirely measured using OptiFlat (trade name) made by Phaseshift Technologies Inc.

By such dummy polishing, the surfaces of the polishing pads used for the rough polishing step described above can be adjusted to a favorable state. Note that the dummy polishing is an optional step. If the surfaces of the polishing pads are adjusted and controlled, the step may be omitted. For example, before the rough polishing is started, the dummy polishing is performed, which allows repetitive execution of multiple batches of rough polishing of the blank substrate for a product, with the adjusted polishing pads.

### (Fine Polishing)

The fine polishing method is not specifically limited, and may be performed according to any of various publicly known methods. For example, the fine polishing of an aluminum alloy substrate can be performed using a polishing liquid containing colloidal silica with a particle diameter of about 0.01 to 0.10 μm, and soft polishing pads. The fine polishing of a glass substrate can be performed using a polishing liquid containing colloidal silica with a particle diameter of about 0.01 to 0.10 μm, in particular, about 10 to 50 nm, and softer polishing pads that are made of urethane foam or the like. It is a matter of course that the condition for the fine polishing is not limited by them. Abrasive grains of cerium oxide, zirconium oxide, SiC, diamond or the like with a desired particle diameter may be used. By such a treatment, the main surface planes of the substrate are polished to mirror surfaces, thus manufacturing a substrate for a magnetic disk. Preferably, the polished substrate is cleaned using a neutral detergent, pure water, IPA or the like.

A specific condition for fine polishing is also affected by the material of the adopted substrate and steps to the rough polishing. Accordingly, it is difficult to uniquely define the condition. There is no limitation to a specific condition. For example, in the fine polishing of the aluminum alloy substrate, a polishing time period may range from 2 to 5 minutes, a polishing surface plate rotational speed may range from 10 to 35 rpm, a sun gear rotational speed may range from 5 to 15 rpm, a polishing liquid supply rate may range from 1000 to 5000 mL/min., a processing pressure may range, for example, from 10 to 200 g/cm², preferably, from 20 to 120 g/cm², in particular, from 50 to 100 g/cm², and a polishing amount may range from 1.0 to 1.5 μm.

The glass substrate fine polishing condition is not specifically limited either. Preferably, for example, soft polishing pads having a hardness of 75 to 77 are used, the polishing surface plate rotational speed ranges from 10 to 35 rpm, the sun gear rotational speed ranges from 5 to 15 rpm, the polishing liquid supply rate ranges from 1000 to 5000 mL/min., the processing pressure ranges from 10 to 200 g/cm², specifically, from 20 to 120 g/cm², in particular, from 50 to 100 g/cm², and the polishing time period ranges from 2 to 12 minutes.

### <Substrate for Magnetic Disk>

According to the method as described above, the substrate for a magnetic disk according to the present invention can be manufactured. The substrate for a magnetic disk in the present invention has a reduced wavy surface defect, thereby significantly improving the reliability of the hard disk.

### <Magnetic Disk>

Sa in the outer peripheral area may be measured after the magnetic material adhesion as described above. The maximum value, the mean value, the standard deviation, and other values of Sa defined for the substrate for a magnetic disk in the embodiment described above can achieve the object in the present invention that is prevention of a head crash even though it is embodied as a magnetic disk to which a magnetic material is added. The present invention also encompasses a magnetic disk where the maximum value of the arithmetic mean heights Sa is 0.50 nm or less when the Sa are defined by ISO25178 and are each measured in a plurality of field-of-view areas positioned in an outer peripheral area on at least one surface using scanning optical interferometry in the middle wavelength region through a Gaussian filter with a cutoff wavelength of 1.0 mm.

The embodiment of the present invention has thus been described above. However, the present invention is not limited by the embodiment described above, encompasses all the aspects included in the concept of the present invention and the claims, and can be variously modified within the scope of the present invention.

For example, even with any of magnetic disks, such as what includes a magnetic material layer, a protective film layer, and a lubrication film layer (magnetic material layer or the like) on a substrate, as long as the maximum value of the arithmetic mean heights Sa is 0.50 mm or less, the wavy surface due to fluttering is reduced, and the object of the present application is achieved.

### EXAMPLES

Hereinafter, the present invention is described in further detail based on Examples. However, the present invention is not limited by them.

### Example 1

A5086 alloy (aluminum alloy A) was melted according to a common procedure, and was DC-cast, and a slab having a length of 7600 mm, a width of 1310 mm, and a plate thickness of 500 mm was fabricated. Each of the front and back surfaces of the fabricated slab was removed by 10 mm, a homogenization treatment at 540° C. for 6 hours was applied, and subsequently hot rolling was performed with a temperature of 540° C., thus achieving a plate thickness of 3.0 mm. The hot-rolled plate was cold-rolled, thus achieving a plate thickness of 0.48 mm. The cold-rolled plate was punched by a press machine to have an inner diameter of φ24 mm×outer diameter of φ98 mm, was flattened by being subjected to a pressure annealing at 320° C. for 3 hours under a pressure of 30 kg/cm². Furthermore, a cutting process was applied to the inner and outer peripheries, thus achieving an inner diameter dimension of φ25 mm×an outer diameter dimension of φ97 mm. In this case, a chamfering process was applied to the inner and outer peripheral end faces at the same time.

The surfaces of the substrate were ground with 4000s SiC grinding stones, thus achieving a plate thickness of 0.46 mm. Here, the carrier plate thickness was 0.40 mm. The substrate was sequentially subjected to a degreasing treatment, and an acid etching treatment, and subsequently subjected to a zincate treatment. The degreasing treatment was performed using, for example, the AD-68F degreasing solution made by C.Uyemura & Co., Ltd., under the conditions of a concentration: 500 mL/L, a temperature: 45° C., and a treatment time period: 3 minutes. The acid etching treatment was performed using, for example, the AD-107F etching solution made by C.Uyemura & Co., Ltd., under the conditions of a concentration: 50 mL/L, a temperature: 60° C., and a treatment time period: 2 minutes. The zincate treatment was performed twice with a nitric acid peeling treatment sandwiched in between. Specifically, the treatments were sequentially performed in an order of a first zincate treatment, pure water cleaning, a nitric acid peeling treatment, pure water cleaning, and a second zincate treatment. The first zincate treatment was performed using, for example, the AD-301F-3X zincate treatment solution made by C. Uyemura & Co., Ltd., under the conditions of a concentration: 200 mL/L, a temperature: 20° C., and a treatment time period: 1 minute. The nitric acid peeling treatment was performed under the conditions of a nitric acid concentration: 30% by volume, a temperature: 25° C., and a treatment time period: 1 minute. The second zincate treatment was performed under the same conditions as those of the first zincate treatment.

Subsequently, the electroless Ni—P plating treatment was performed. The electroless Ni—P plating treatment was performed using the NIMUDEN® HDX electroless plating solution made by C. Uyemura & Co., Ltd., under the conditions of an Ni concentration: 6 g/L, a temperature: 88° C., and a treatment time period: 130 minutes, thus forming an electroless Ni—P plating film having a thickness of 13 μm on each of the opposite surfaces.

A rough polishing treatment was applied to both the electroless-Ni—P-plated surfaces (front and back surfaces). The rough polishing treatment was performed through double-side polishing, using hard urethane polishing pads having a hardness of 87, and abrasive grains having a particle diameter of 0.4 μm. The carrier plate thickness in the rough polishing step was 0.40 mm. Note that in the rough polishing step, the polishing surface plate rotational speed was 30 rpm, the sun gear rotational speed was 10 rpm, the polishing liquid supply rate was 3500 cc/min, and the processing pressure was 100 g/cm².

Note that before the rough polishing treatment described above, dummy polishing was performed. For the dummy polishing, another electroless-Ni—P-plated substrate fabricated in a manner similar to that described above was used as a dummy substrate. The dummy polishing was performed multiple times under the same conditions as the rough polishing conditions described above. At the sixth time, the OptiFlat Wa (arithmetic mean waviness measured in a long-wavelength region with a cutoff wavelength of 0.4 to 5.0 mm: long-wavelength waviness) of the dummy substrate became less than 2.5 nm (2.19 nm). Accordingly, the dummy polishing was finished. Note that measurement of the arithmetic mean waviness Wa of the dummy substrate was performed using OptiFlat (trade name) made by Phaseshift Technologies Inc., over the entire one surface of the roughly polished dummy substrate.

After the roughly polished substrate was cleaned with pure water, fine polishing was applied, and a substrate for a magnetic disk with a plate thickness (thickness dimension) of 0.48 mm was fabricated. The fine polishing was performed using soft urethane polishing pads with a hardness of 76, and colloidal silica abrasive grains with a particle diameter of 0.08 μm, under the conditions similar to the rough polishing conditions except that the polishing time period was 5 minutes, and the processing pressure was 50 to 100 g/cm².

### Comparative Example 1

In the rough polishing, operations similar to those in Example 1 except that a double-sided polisher with the thickness dimension of the carrier of 0.3 mm was used were performed, thus fabricating a substrate for a magnetic disk.

### Example 2

A glass material melt with a component composition containing SiO₂: 65% by mass, Al₂O₃: 18% by mass, Li₂O: 4% by mass, Na₂O: 1% by mass, K₂O: 0.2% by mass, CaO: 4% by mass, and ZrO₂: 0.8% by mass was heated and fused at 1600 to 1700° C., thus preparing a glass material (step S201). Next, the prepared glass material melt was formed by the redraw method into an aluminosilicate glass plate with 100 mm and a length of 10 m (step S202). Subsequently, a glass plate with a thickness close to 0.6 mm was selected, subjected to coring, and the end faces of the inner and outer peripheries were polished (cutting of the inner and outer diameters of the glass disk, dimension adjustment, chamfering process, and grinding process to chamfered portions), thus forming an annular glass substrate with an outer diameter dimension of 97 mm and a circular hole inner diameter dimension of 25 mm (steps S203 and S204).

Subsequently, the formed glass substrate was set in a double-sided polisher, and was subjected to a rough polishing treatment and a fine polishing treatment, thus fabricating a substrate for a magnetic disk with a plate thickness of 0.48 mm. The carrier plate thickness in the rough polishing step was 0.40 mm. Note that in this Example, the blank substrate was fabricated by the redraw method, and the variation in plate thickness was allowed to be ignored. Accordingly, the lapping step in S205 was omitted. Since the polishing pads were controlled in a favorable state, the dummy polishing was not executed either. The rough polishing treatment used hard urethane polishing pads with a hardness of 87, and a polishing liquid containing loose grains obtained by applying pure water to cerium oxide polishing abrasive grains with an average particle diameter of 0.19 μm. The polishing surface plate rotational speed was 25 rpm, the polishing liquid supply rate was 1500 cc/min, and the processing pressure was 120 g/cm², and the operations were performed in a manner similar to those in Example 1.

The fine polishing treatment used soft urethane polishing pads with a hardness of 76, and a polishing liquid containing loose grains obtained by applying pure water to colloidal silica with an average particle diameter of 0.08 μm, and the polishing time period was 8.5 minutes, the processing pressure was 50 to 120 g/cm², and the operations were performed in a manner similar to that of Example 1. The thickness dimension of the obtained substrate was an actually measured value of 0.48 mm.

### Comparative Example 2

Operations similar to those in Example 2 were performed except that the rough polishing carrier is 0.3 mm, thus fabricating a substrate for a magnetic disk. A measurement result of Sa in the outer peripheral area was shown in Table 1.

For each fabricated substrate for a magnetic disk, Sa in the outer peripheral area was measured. The measurement method was as follows.

### (Sa in Outer Peripheral Area)

Sa in the outer peripheral area was measured by VS1800 made by Hitachi High-Tech Science Corporation to which an objective lens with 2.5× magnification was attached. As shown in FIG. 1, the arithmetic mean heights Sa were measured according to ISO25178 in the middle wavelength region with the cutoff wavelength of 1.0 mm (Gaussian filter) in eight field-of-view areas with each side of 4.75 mm that were evenly positioned in the outer peripheral area and were in internal contact with the virtual outer circle 5 closer to the center by 1 mm than the outer peripheral edge 3 of the disk, and the maximum value, the mean value and the like were calculated.

Based on the measurement result, each substrate for a magnetic disk was evaluated with respect to the following reference. The result is shown in Table 1.
Good (indicated by circle symbol “∘”): a case with the maximum value of Sa in the outer peripheral area less than or equal to 0.50 nm or less
Poor (indicated by cross symbol “x”): a case with the maximum value of Sa in the outer peripheral area greater than 0.50 nm

Note that each substrate for a magnetic disk evaluated as Good “∘” according to the reference were determined to have no problem by the test in the hard disk drive manufacturing step. On the other hand, the substrate for a magnetic disk evaluated as Poor “x” were determined to have a problem by the same test. Consequently, in the following Table 1, these symbols “∘” and “x” are described as indicators of the hard disk (HD) performance.

TABLE 1

| | | Examples | | | |
|---|---|---|---|---|---|
| | | Example | Comparative | Example | Comparative |
| | | 1 | Example 1 | 2 | Example 2 |
| | | (substrate) ^{#} | | | |
| | | (Al) | (Al) | (glass) | (glass) |
| Sa | maximum | 0.406 | 0.588 | 0.360 | 0.542 |
| | value* | | | | |
| | mean value* | 0.289 | 0.413 | 0.227 | 0.437 |
| | standard | 0.083 | 0.109 | 0.071 | 0.124 |
| | deviation* | | | | |

| | | | | |
|---|---|---|---|---|
| HD performance | ∘ | x | ∘ | x |

*unit: nm
^{#} material of the substrate (Al: aluminum alloy)

According to the present invention, each substrate for a magnetic disk in Examples 1 and 2 where the maximum value of the arithmetic mean height Sa in eight field-of-view areas in the outer peripheral area was 0.50 nm or less caused no problem even in tests in a hard disk drive manufacturing step. On the other hand, each substrate for a magnetic disk in Comparative Examples 1 and 2 with the maximum value greater than 0.50 nm caused problems in tests in the hard disk drive manufacturing step. The present invention has demonstrated to provide a substrate for a magnetic disk that has a small wall thickness, but prevents the waviness in the disk outer peripheral area (wavy surface defect), and is unlikely to cause a problem in the hard disk drive.

### EXPLANATION OF REFERENCE NUMERALS

1 Substrate for a magnetic disk
2 Outer peripheral area
3 Outer peripheral edge
4 Virtual inner circle
5 Virtual outer circle
6 Field-of-view area

1. A substrate for a magnetic disk, having a maximum value of arithmetic mean heights Sa of 0.50 nm or less and a standard deviation of the arithmetic mean heights Sa of 0.10 nm or less,
wherein the arithmetic mean heights Sa are defined by ISO25178 and are each measured in a plurality of field-of-view areas positioned in an outer peripheral area on at least one surface using scanning optical interferometry in a middle wavelength region through a Gaussian filter with a cutoff wavelength of 1.0 mm.

2. The substrate for a magnetic disk according to claim 1, having a mean value of the arithmetic mean heights Sa of 0.40 nm or less.

3. The substrate for a magnetic disk according to claim 1 or 2, having a thickness of less than 0.50 mm.

4. The substrate for a magnetic disk according to claim 1 or 2, having an outer diameter dimension of 95 mm or more.

5. A magnetic disk, having a maximum value of arithmetic mean heights Sa of 0.50 nm or less and a standard deviation of the arithmetic mean heights Sa of 0.10 nm or less,
wherein the arithmetic mean heights Sa are defined by ISO25178 and are each measured in a plurality of field-of-view areas positioned in an outer peripheral area on at least one surface using scanning optical interferometry in a middle wavelength region through a Gaussian filter with a cutoff wavelength of 1.0 mm.

6-9. (canceled)
